(19) United States
(12) Patent Application Publication
(10) Pub. No.: US 2022/0299651 A1
(43) Pub. Date: Sep. 22, 2022

(54) POSITIONING ASSISTANCE APPARATUS, POSITIONING ASSISTANCE METHOD, AND COMPUTER-READABLE RECORDING MEDIUM

(71) Applicant: NEC Solution Innovation, Ltd., Koto-ku, Tokyo (JP)

(72) Inventors: Ryo MIYAMOTO, Tokyo (JP); Maho KASHIWAGI, Tokyo (JP); Yuka KANDA, Tokyo (JP)

(73) Assignee: NEC Solution Innovation, Ltd., Koto-ku, Tokyo (JP)

(21) Appl. No.: 17/636,472

(22) PCT Filed: Aug. 20, 2020
(86) PCT No.: PCT/JP2020/031510

§ 371 Date: Feb. 18, 2022

(30) Foreign Application Priority Data
Sep. 5, 2019 (JP) 2019-162453

(51) Int. Cl. G01S 19/07

(52) U.S. Cl. CPC G01S 19/07

(57) ABSTRACT

A positioning assistance apparatus 1 that improves positioning accuracy includes a positioning error calculation unit 2 that calculates a positioning error using a reference position indicating a position of a generation-side apparatus 10 that generates local correction information and an estimated position indicating a position of the generation-side apparatus 10 estimated based on a positioning signal received from a satellite, and a use determination unit 3 that determines whether or not to use local correction information based on the calculated positioning error.

### TECHNICAL FIELD

The invention relates to a positioning assistance apparatus and a positioning assistance method for assisting satellite positioning, and in particular relates to a computer-readable recording medium on which a program for realizing the apparatus and method is recorded.

### BACKGROUND ART

In order to accurately perform satellite positioning, error factors such as (1) satellite orbit error, (2) satellite clock error, (3) ionosphere delay, (4) tropospheric delay, (5) signal shielding, and (6) multipath need to be taken into consideration.

In view of this, techniques such as PPP (Precise Point Positioning) have been proposed. However, it is difficult to perform accurate satellite positioning when only information received from the satellite is used.

In recent years, in order to further improve the accuracy of satellite positioning, techniques such as MADOCA (Multi-GNSS (Global Navigation Satellite System) Advanced Demonstration tool for Orbit and Clock Analysis)-PPP have been proposed.

Specifically, (1) satellite orbit error and (2) satellite clock error are reduced using MADOCA correction information. (3) Ionosphere delay error and (4) troposphere delay error are reduced using local correction information. (5) Signal shielding and (6) multipath errors are reduced using radio waves transmitted from a high elevation angle satellite (quasi-zenith satellite, etc.).

As a related technique, Patent Document 1 discloses a positioning apparatus for improving the accuracy of satellite positioning. With the positioning apparatus of Patent Document 1, positioning computation processing is carried out using correction information obtained through a satellite channel and a terrestrial channel (global correction information and local correction information) and observation data generated based on a positioning signal transmitted from the satellite. In addition, when content of newly obtained correction information and content of correction information stored in advance (target satellites or information types) overlap, the positioning apparatus of Patent Document 1 calculates reliabilities thereof, and selects the information with a higher reliability.

### LIST OF RELATED ART DOCUMENTS

### Patent Document

Patent document 1: Japanese Patent Laid-Open Publication No. 2018-205244

### SUMMARY

### Technical Problems

However, the positioning apparatus disclosed in Patent Document 1 calculates a reliability using the distance between a local generation station and the positioning apparatus or a standard deviation for which positioning results of the local generation station are used as a population, in addition to a time for which local correction information has been held (freshness of information), and updates the local correction information in accordance with the calculated reliability, but measurement error is not used.

An example object of the invention is to provide a positioning assistance apparatus, a positioning assistance method, and a computer-readable recording medium for improving the positioning accuracy.

### Solution to the Problems

In order to achieve the aforementioned object, a positioning assistance apparatus according to an example aspect is a positioning assistance apparatus to be provided in a generation-side apparatus that generates local correction information, including:

a positioning error calculation unit that calculates a positioning error using a reference position indicating a position of the generation-side apparatus that generates the local correction information and an estimated position indicating a position of the generation-side apparatus estimated based on a positioning signal received from a satellite; and

a use determination unit that determines whether or not to use the local correction information, based on the calculated positioning error.

In addition, in order to achieve the aforementioned object, a positioning assistance apparatus according to an example aspect is a positioning assistance apparatus to be provided in a use-side apparatus that uses local correction information, including:

a use determination unit that determines whether or not to use the local correction information, based on a positioning error calculated using a reference position indicating a position of a generation-side apparatus that generates the local correction information and an estimated position indicating a position of the generation-side apparatus estimated based on a positioning signal received from a satellite.

In addition, in order to achieve the aforementioned object, a positioning assistance method according to an example aspect is a positioning assistance method for a generation-side apparatus that generates local correction information, the method including:

a positioning error calculation step of calculating a positioning error using a reference position indicating a position of the generation-side apparatus that generates the local correction information and an estimated position indicating a position of the generation-side apparatus estimated based on a positioning signal received from a satellite; and

a use determination step of determining whether or not to use the local correction information, based on the calculated positioning error.

In addition, in order to achieve the aforementioned object, a positioning assistance method according to an example aspect is a positioning assistance method for a use-side apparatus that uses local correction information, the method including:

a positioning error calculation step of calculating a positioning error using a reference position indicating a position of a generation-side apparatus that generates the local correction information and an estimated position indicating a position of the generation-side apparatus estimated based on a positioning signal received from a satellite, and

a use determination step of determining whether or not to use the local correction information, based on the calculated positioning error.

In addition, in order to achieve the aforementioned object, a computer-readable recording medium according to an example aspect includes a program recorded thereon, the program including instructions that cause a computer of a generation-side apparatus that generates local correction information to carry out:

a positioning error calculation step of calculating a positioning error using a reference position indicating a position of the generation-side apparatus that generates the local correction information and an estimated position indicating a position of the generation-side apparatus estimated based on a positioning signal received from a satellite, and

a use determination step of determining whether or not to use the local correction information, based on the calculated positioning error.

Moreover, in order to achieve the aforementioned object, a computer-readable recording medium according to an example aspect of the invention includes a program recorded thereon, the program including instructions that cause a computer of a use-side apparatus that uses local correction information to carry out:

a positioning error calculation step of calculating a positioning error using a reference position indicating a position of a generation-side apparatus that generates the local correction information and an estimated position indicating a position of the generation-side apparatus estimated based on a positioning signal received from a satellite, and

a use determination step of determining whether or not to use the local correction information, based on the calculated positioning error.

Furthermore, in order to achieve the aforementioned object, a system according to an example aspect of the invention is a system including a generation-side apparatus and a use-side apparatus,

the generation-side apparatus calculating a positioning error using a reference position indicating a position of the generation-side apparatus that generates local correction information and an estimated position indicating a position of the generation-side apparatus estimated based on a positioning signal received from a satellite, and

the use-side apparatus determining whether or not to use the local correction information, based on the calculated positioning error.

### Advantageous Effects of the Invention

As described above, according to the invention, it is possible to improve the positioning accuracy.

### BRIEF DESCRIPTION OF THE DRAWINGS

FIG. 1 is a diagram showing an example of a positioning assistance apparatus.

FIG. 2 is a diagram for describing an example of a system that includes positioning assistance apparatuses.

FIG. 3 is a diagram for describing use of local correction information.

FIG. 4 is a diagram for describing use of local correction information.

FIG. 5 is a diagram for describing an example of operations of a positioning assistance apparatus of a generation-side apparatus.

FIG. 6 is a diagram for describing an example of operations of a positioning assistance apparatus of a use-side apparatus.

FIG. 7 is a diagram for describing an example of a system that includes positioning assistance apparatuses.

FIG. 8 is a diagram for describing an example of operations of a positioning assistance apparatus of a generation-side apparatus.

FIG. 9 is a diagram for describing an example of operations of a positioning assistance apparatus of a use-side apparatus.

FIG. 10 is a diagram for describing an example of a system that includes a positioning assistance apparatus.

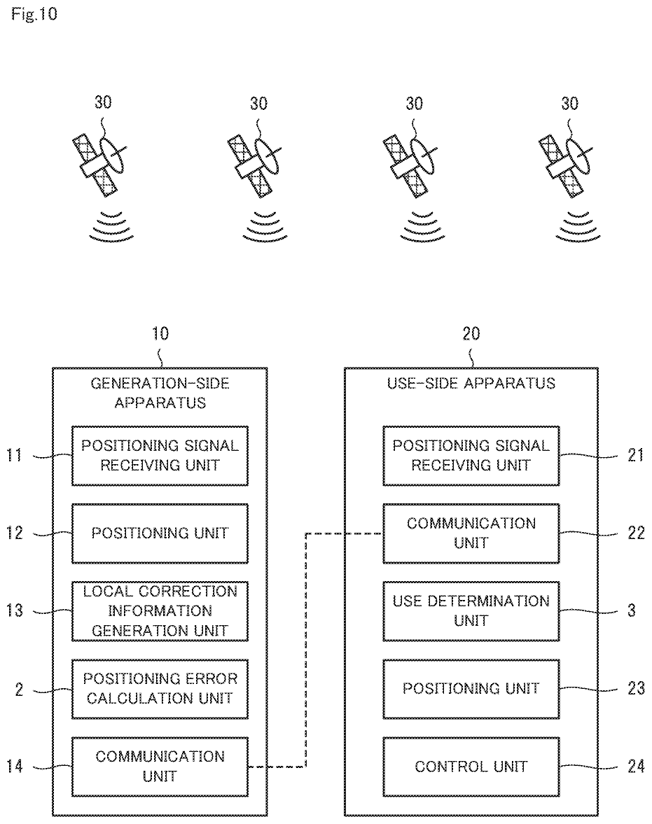

FIG. 11 is a diagram for describing an example of a computer that realizes a positioning assistance apparatus.

### EXAMPLE EMBODIMENT

### First Example Embodiment

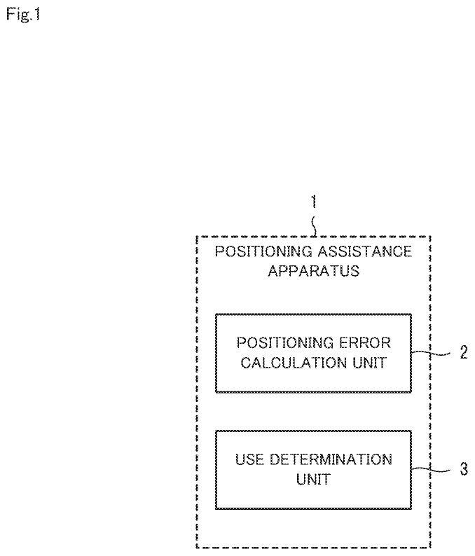

The following describes a first example embodiment with reference to FIGS. 1 to 6.

[Apparatus Configuration]

First, a configuration of a positioning assistance apparatus according to the first example embodiment will be described with reference to FIG. 1. FIG. 1 is a diagram for describing an example of the positioning assistance apparatus.

A positioning assistance apparatus 1 shown in FIG. 1 is an apparatus for improving the positioning accuracy. In addition, as shown in FIG. 1, the positioning assistance apparatus 1 includes a positioning error calculation unit 2 and a use determination unit 3.

Of these, the positioning error calculation unit 2 calculates a positioning error using a reference position indicating a position of a generation-side apparatus that generates local correction information and an estimated position indicating a position of the generation-side apparatus estimated based on a positioning signal received from a satellite. The use determination unit 3 determines whether or not to use the local correction information, based on the calculated positioning error.

As described above, in the present example embodiment, it is determined whether or not to use the local correction information, based on the positioning error, and positioning can be performed using valid local correction information that can be used, thus enabling the positioning accuracy to be improved. Note that the local correction information includes at least information for correcting (3) ionosphere delay error and (4) troposphere delay error.

[System Configuration]

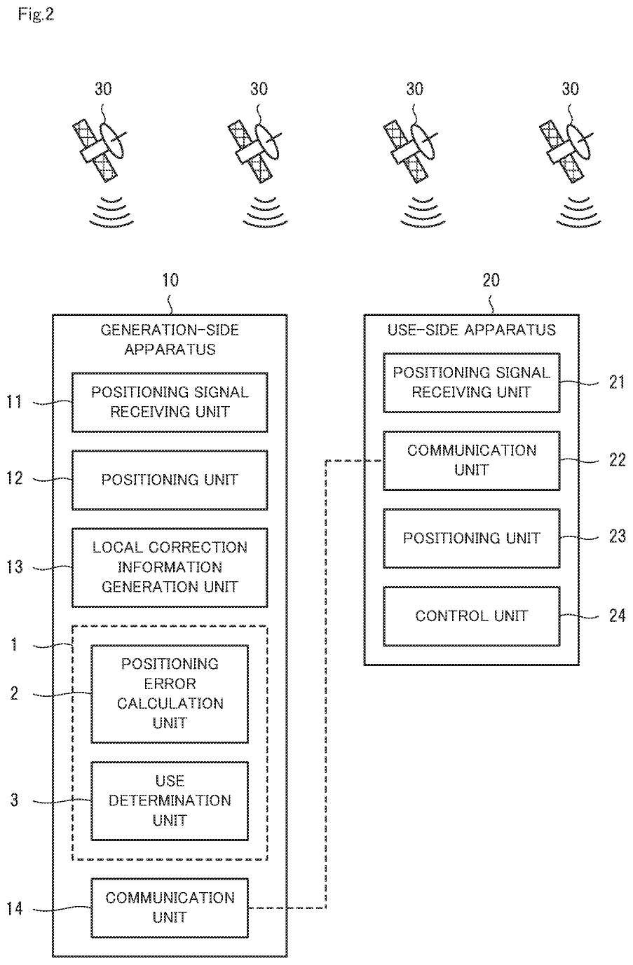

Next, the configuration of the positioning assistance apparatus 1 according to the first example embodiment will be described in more detail with reference to FIG. 2. FIG. 2 is a diagram showing an example of a system that includes positioning assistance apparatuses.

As shown in FIG. 2, the system according to the first example embodiment includes a generation-side apparatus 10 (generation station) and a use-side apparatus 20. In addition, the generation-side apparatus 10 and the use-side apparatus 20 receive radio waves from positioning satellites 30. The generation-side apparatus 10 includes the positioning error calculation unit 2, the use determination unit 3, a positioning signal receiving unit 11, a positioning unit 12, a local correction information generation unit 13, and a communication unit 14. In addition, the use-side apparatus 20 includes a positioning signal receiving unit 21, a communication unit 22, a positioning unit 23, and a control unit 24.

The system will be described.

Examples of the system include a satellite positioning system and the like. A GNSS (Global Navigation Satellite System), for example, is conceivable as the satellite positioning system. Specifically, in the satellite positioning system, the generation-side apparatus 10 and the use-side apparatus 20 calculate present positions thereof based on positioning signals transmitted from the plurality of positioning satellites 30 shown in FIG. 2.

The generation-side apparatus 10 receives positioning signals from the positioning satellites 30, and generates local correction information that is valid in a service area. The generation-side apparatus 10 then transmits the generated local correction information to the use-side apparatus 20. The generation-side apparatus 10 is installed on the ground, for example.

The service area is a region that is set based on the position at which the generation-side apparatus 10 is installed, for example.

The use-side apparatus 20 receives positioning signals from the positioning satellites 30, demodulates the received positioning signals, and generates observation data. In addition, the use-side apparatus 20 receives local correction information from the generation-side apparatus 10. The use-side apparatus 20 then calculates a present position thereof based on the generated observation data and the local correction information that is valid in the service area. Furthermore, the use-side apparatus 20 provides information indicating the calculated present position to various applications.

The use-side apparatus 20 is mounted in a mobile object or the like. Examples of the mobile object include vehicles, flight vehicles, vessels, mobile devices, and the like. A navigation system, an automated driving system, or the like is conceivable as an application.

Each positioning satellite 30 revolves on a predetermined satellite orbit in a predetermined orbit period. The positioning satellite 30 transmits a positioning signal obtained by phase-modulating data indicating a transmission time and the like.

The generation-side apparatus 10 that generates local correction information will be described.

The positioning signal receiving unit 11 receives positioning signals transmitted from the positioning satellites 30, via a monitor apparatus for monitoring radio waves from the positioning satellites 30 disposed in the vicinity of the generation-side apparatus 10, demodulate the received positioning signals, and generates observation data. Specifically, the positioning signal receiving unit 11 includes an antenna that receives positioning signals, a circuit for demodulating positioning signals, and the like.

Data such as identification information for identifying positioning satellites, observation times at which positioning signals used for generating observation data were received, a Doppler shift amount indicating the difference between a carrier frequency and a received frequency caused by the Doppler effect, satellite coordinates indicating the present positions on the satellite orbits of the positioning satellites 30, a pseudo distance indicating the difference between a time at which a positioning signal was transmitted from each positioning satellite 30 and a time at which the positioning signal was received by the positioning signal receiving unit 11, and the carrier phase, for example, is conceivable as the observation data.

The positioning unit 12 calculates position coordinates of the generation-side apparatus 10 using the observation data. PPP-AR, MADOCA-PPP, or the like can be used as a positioning method.

The local correction information generation unit 13 generates local correction information for each positioning satellite 30 based on the observation data, and stores the generated local correction information in a storage unit provided in the local correction information generation unit 13 (not illustrated in FIG. 2). Note that the storage unit is a storage device such as a database provided inside or outside the generation-side apparatus 10.

Information such as identification numbers for identifying satellites, a generation time at which local correction information was generated, position coordinates of the generation-side apparatus 10, a position coordinate deviation that indicates variation of position coordinates during a certain period of time, ionosphere correction information, and troposphere correction information is stored as the local correction information.

The positioning error calculation unit 2 calculates a positioning error in time series using position coordinates (reference position) indicating the position of the generation-side apparatus 10 and position coordinates (estimated position) of the generation-side apparatus 10 estimated based on positioning signals received from satellites. The reference position refers to the position coordinates of the generation-side apparatus 10 measured in advance.

The positioning error calculation unit 2 calculates the distance between two points in a three-dimensional space (between the reference position and the estimated position), for example, and regards the distance as a positioning error.

The use determination unit 3 determines whether or not to use the local correction information, based on the calculated positioning error using methods (i), (ii), and (iii) below.

(i) If the positioning error is smaller than or equal to a preset first threshold value, the use determination unit 3 determines that the local correction information can be used. The first threshold value is determined through testing, simulation, and the like.

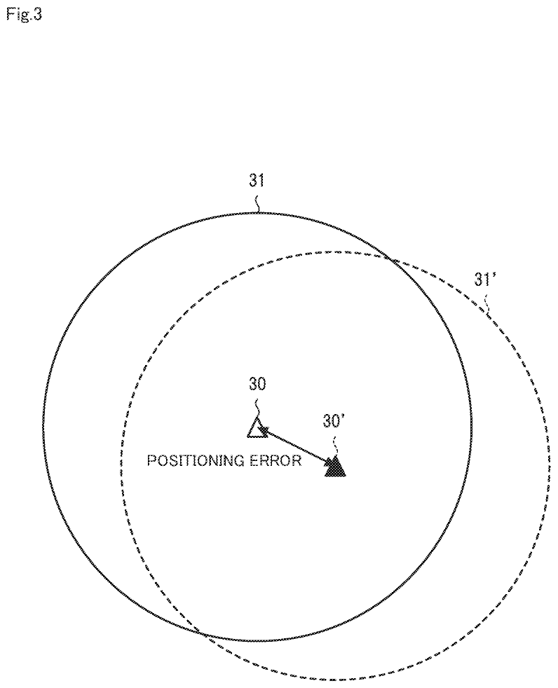

FIG. 3 is a diagram for describing use of local correction information. The triangle 30 shown in FIG. 3 indicates position coordinates indicating the reference position of the generation-side apparatus 10. The black triangle 30′ shown in FIG. 3 indicates estimated position coordinates of the generation-side apparatus 10. The solid line circle 31 shown in FIG. 3 indicates a service area corresponding to the correct position coordinates. The broken line circle 31′ shown in FIG. 3 indicates a service area corresponding to the estimated position coordinates.

In a case of (i), if the positioning error is smaller than or equal to a preset first threshold value, it is determined that the local correction information can be used, and state information indicating that the local correction information is valid is generated. The use determination unit 3 associates the local correction information and the state information with each other, and transmits them to the use-side apparatus 20 via a communication unit 14. Note that, when the positioning error is larger than the first threshold value, it is determined that the local correction information cannot be used, and state information indicating that that local correction information is invalid is generated.

(ii) The use determination unit 3 first counts the numerical quantity of positioning errors that are smaller than or equal to the first threshold value, every set time. Next, if the counted numerical quantity is larger than or equal to a second threshold value that is used for determining whether or not to use the local correction information (threshold value for determining the convergence status), the use determination unit 3 determines that the local correction information is to be used. The second threshold value is determined through testing, simulation, and the like.

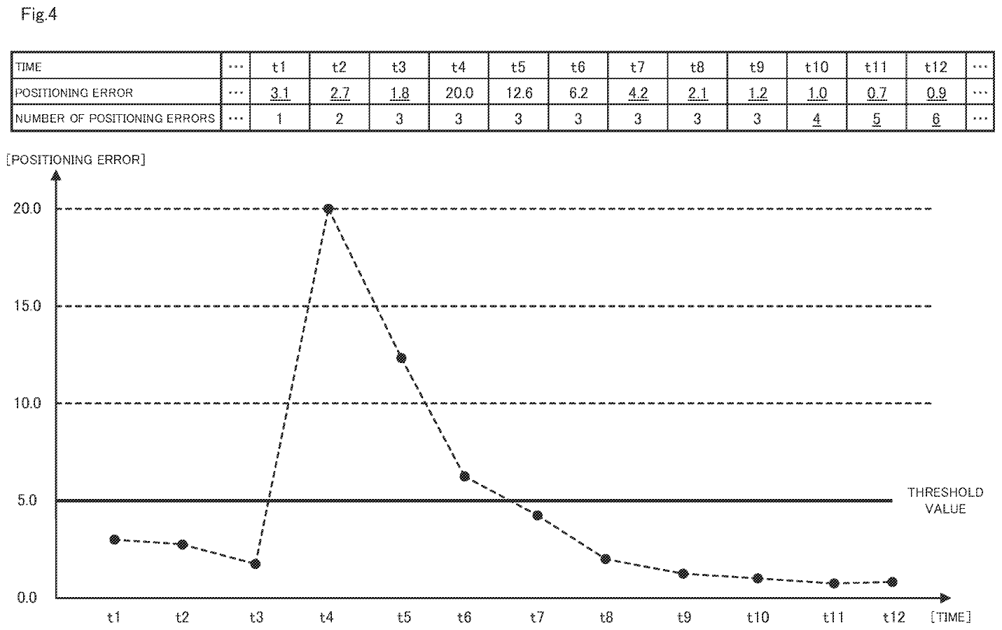

In (ii), determination of the convergence status of past positioning errors is performed instead of performing determination of the positioning error in real time as in (i). A detailed description will be given with reference to FIG. 4.

FIG. 4 is a diagram for describing use of local correction information. The table shown in FIG. 4 is a table in which time, positioning error, and numerical quantity are associated with each other. Times t1 to t12 in FIG. 4 are times at which positioning errors were calculated. The positioning errors in FIG. 4 are positioning errors calculated at times t1 to t12, respectively. The numerical quantity in FIG. 4 is a value obtained by counting, during a preset setting time, the numerical quantity of obtained positioning errors that are larger than or equal to the first threshold value, every time six positioning errors, which is a preset numerical quantity, are obtained. Note that the numerical quantity for obtaining positioning errors is not limited to six.

The graph shown in FIG. 4 is a graph in which the vertical axis indicates positioning error, and the horizontal axis indicates time. In FIG. 4, the first threshold value is 5.0 [cm], and the second threshold value is 4.

In the example in FIG. 4, at times before time t10, the numerical quantity of positioning errors that are smaller than or equal to the first threshold value is smaller than four (the second threshold value), and thus the use determination unit 3 determines that local correction information corresponding to times before time t10 cannot be used. In contrast, at times t10 to t12, the numerical quantity of positioning errors that are smaller or equal to the first threshold value is four (the second threshold value) or larger, and thus the use determination unit 3 determines that local correction information corresponding to these times can be used.

(iii) The use determination unit 3 first executes statistical processing on positioning errors for each set time and calculates a statistical value. Next, if the calculated statistical value satisfies a statistical value determination condition that is used for determining whether or not to use the local correction information, the use determination unit 3 determines that the local correction information is to be used.

That is to say, the use determination unit 3 calculates a statistical value such as an average value or a median value using a plurality of past positioning errors. Then, if the calculated statistical value satisfies the statistical value determination condition corresponding to the calculated statistical value, the use determination unit 3 determines that the local correction information is to be used. The statistical value determination condition is a determination condition set for the average value or the median value, for example. The statistical value determination condition is determined through testing, simulation, and the like.

The communication unit 14 transmits the local correction information and state information indicating whether or not the local correction information is valid, to the communication unit 22 of the use-side apparatus 20. Specifically, the communication unit 14 is a communication apparatus that performs communication such as wired or wireless communication.

The use-side apparatus 20 that uses the local correction information will be described.

The positioning signal receiving unit 21 receives positioning signals transmitted from the positioning satellites 30, demodulates the received positioning signals, and generates observation data. Specifically, the positioning signal receiving unit 21 includes an antenna that receives positioning signals, a circuit for demodulating positioning signals, and the like.

The communication unit 22 receives the local correction information and the state information from the communication unit 14 of the generation-side apparatus 10. Specifically, the communication unit 14 is a communication apparatus that performs communication such as wired or wireless communication.

The positioning unit 23 calculates position coordinates of the use-side apparatus 20 using the observation data and the local correction information. Specifically, when local correction information determined to be usable is received, the positioning unit 23 calculates position coordinates of the use-side apparatus 20 using the observation data and the local correction information.

In addition, if the local correction information is invalid, the positioning unit 23 calculates position coordinates of the use-side apparatus 20 using only the observation data, without using the local correction information. PPP-AR, MADOCA-PPP, and the like can be used as a positioning method.

The control unit 24 controls an apparatus in which the use-side apparatus 20 is mounted (for example, a vehicle, a flight vehicle, a vessel, or a mobile device) or an application installed in the use-side apparatus 20 (for example, a navigation system), using the position coordinates calculated by the use-side apparatus 20. Specifically, the control unit 24 is a circuit that includes a processor and the like.

[Apparatus Operations]

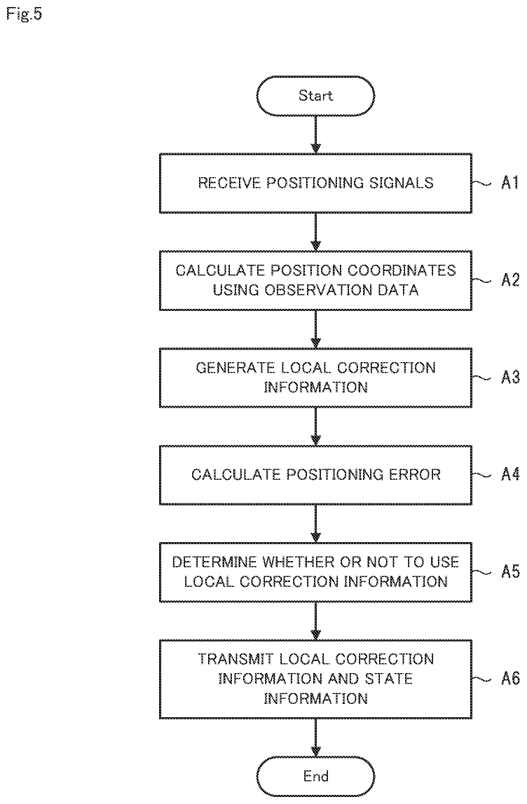

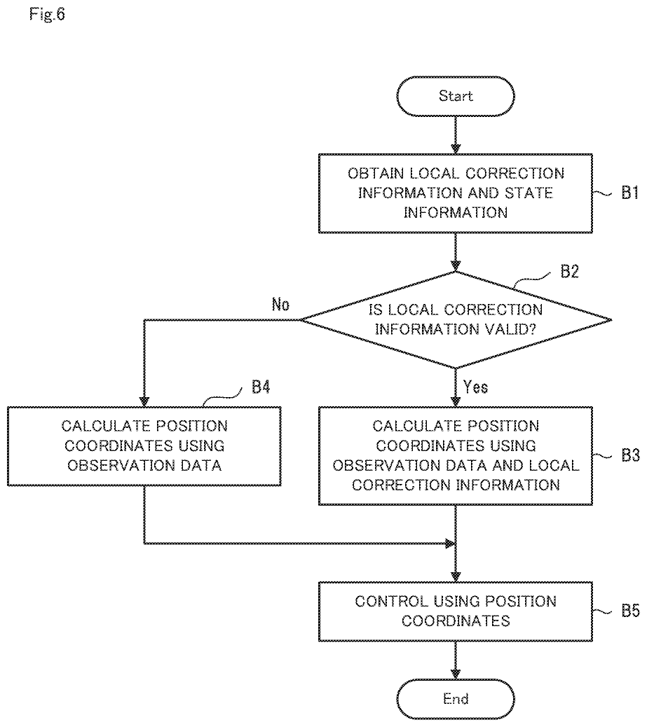

Next, operations of the positioning assistance apparatuses according to first example embodiment will be described with reference to drawings. FIG. 5 is a diagram for describing an example of operations of the positioning assistance apparatus of the generation-side apparatus. FIG. 6 is a diagram for describing an example of operations of the positioning assistance apparatus of the use-side apparatus. In the following description, FIGS. 2 to 4 will be referred to as appropriate. In addition, in the first example embodiment, a positioning assistance method is carried out by operating the positioning assistance apparatuses. Thus, description of the positioning assistance method according to the first example embodiment is replaced by the following description of operations of the positioning assistance apparatuses.

Operations of the generation-side apparatus will be described with reference to FIG. 5.

First, the positioning signal receiving unit 11 receives positioning signals transmitted from the positioning satellites 30, via the monitor apparatus for monitoring radio waves from the positioning satellites 30 disposed in the vicinity of the generation-side apparatus 10, demodulates the received positioning signals, and generates observation data (step A1).

Next, the positioning unit 12 calculates position coordinates of the generation-side apparatus 10 using the observation data (step A2). The local correction information generation unit 13 then generates local correction information for each positioning satellite 30 based on the observation data, and stores the generated local correction information in the storage unit (step A3).

Next, the positioning error calculation unit 2 calculates a positioning error using the position coordinates (reference position) indicating the precise position of the generation-side apparatus 10 and the position coordinates (estimated position) of the generation-side apparatus 10 estimated based on the positioning signals received from satellites (step A4). The positioning error calculation unit 2 calculates the distance between two points in a three-dimensional space (between the reference position and the estimated position), and regards the distance as a positioning error, for example.

Next, the use determination unit 3 determines whether or not to use the local correction information, based on the calculated positioning error (step A5). It is determined whether or not to use the local correction information using the above-described (i)(ii)(iii) methods, for example.

If it is determined in step A5 that the local correction information is to be used, the communication unit 14 transmits the local correction information and state information indicating that the local correction information is valid to the communication unit 22 of the use-side apparatus 20 (step A6). If it is determined in step A5 that the local correction information is not to be used, the local correction information and state information indicating the local correction information is invalid are transmitted to the use-side apparatus 20 (step A6).

Operations of the use-side apparatus will be described with reference to FIG. 6.

First, the communication unit 22 obtains local correction information and state information from the generation-side apparatus 10 via the communication unit 14 (step B1).

Next, the positioning unit 23 determines whether or not the local correction information is valid using the state information (step B2). If it is determined in step B2 that the local correction information is valid (step B2: Yes), the positioning unit 23 calculates position coordinates of the use-side apparatus 20, using observation data and the valid local correction information (step B3).

In addition, if it is determined in step B2 that the local correction information is not valid (step B2: No), the positioning unit 23 calculates position coordinates of the use-side apparatus 20 using the observation data (step B4).

Next, the control unit 24 controls an apparatus (for example, a vehicle, a flight vehicle, a vessel, or a mobile device) in which the use-side apparatus 20 is mounted or an application (for example, a navigation system) in which the use-side apparatus 20 is installed, using the position coordinates calculated by the use-side apparatus 20 (step B5).

### Effects in First Example Embodiment

As described above, according to the first example embodiment, it is determined whether or not to use local correction information, based on a positioning error, and positioning can be performed using valid local correction information, thus enabling the positioning accuracy to be increased.

[Program]

A program according to the first example embodiment may be a program for causing a generation-side computer to execute steps A1 to A6 shown in FIG. 5. In addition, the program according to the first example embodiment may be a program for causing a use-side computer to execute steps B1 to B5 shown in FIG. 6.

It is possible to realize the generation-side or use-side positioning assistance apparatus and the positioning assistance method according to the first example embodiment by installing these programs onto corresponding computers, and executing the programs. In this case, the processor of the generation-side computer functions as the positioning unit 12, the local correction information generation unit 13, the positioning error calculation unit 2, and the use determination unit 3, and performs processing. In addition, the processor of the user-side computer functions as the positioning unit 23 and the control unit 24, and performs processing.

In addition, the program according to the first example embodiment may also be executed by a computer system constituted by a plurality of computers. Each generation-side computer may function as one of the positioning unit 12, the local correction information generation unit 13, the positioning error calculation unit 2, and the use determination unit 3, for example. Each use-side computer may function as one of the positioning unit 23 and the control unit 24, for example.

### Second Example Embodiment

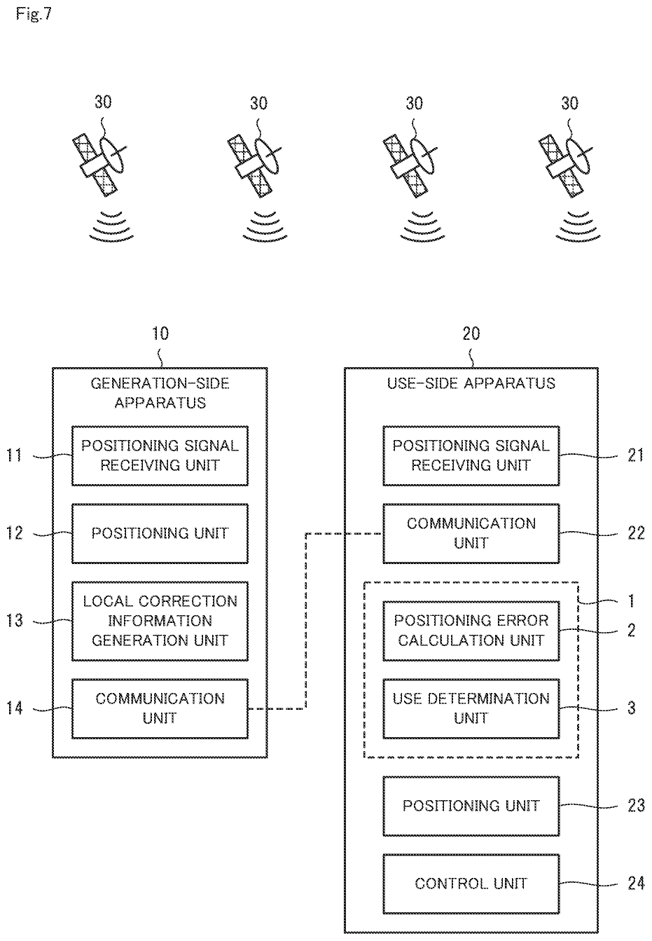

A second example embodiment will be described below with reference to FIGS. 7 to 9.

[System Configuration]

Next, the configuration of a positioning assistance apparatus 1 according to the second example embodiment will be described in greater detail with reference to FIG. 7. FIG. 7 is a diagram showing an example of a system that includes the positioning assistance apparatus.

As shown in FIG. 7, the system according to the second example embodiment includes the generation-side apparatus 10 (generation station) and the use-side apparatus 20. In addition, the generation-side apparatus 10 and the use-side apparatus 20 receive radio waves from positioning satellites 30. The generation-side apparatus 10 includes the positioning signal receiving unit 11, the positioning unit 12, the local correction information generation unit 13, and the communication unit 14. In addition, the use-side apparatus 20 includes the positioning error calculation unit 2, the use determination unit 3, the positioning signal receiving unit 21, the communication unit 22, the positioning unit 23, and the control unit 24.

The generation-side apparatus 10 that generates local correction information will be described.

Operations of the positioning signal receiving unit 11, the positioning unit 12, and the local correction information generation unit 13 according to the second example embodiment are the same as those of the first example embodiment, and thus a description of the positioning signal receiving unit 11, the positioning unit 12, and the local correction information generation unit 13 is omitted.

The communication unit 14 transmits local correction information, position coordinates indicating the position of the generation-side apparatus 10 (reference position), and estimated position coordinates of the generation-side apparatus 10 (estimated position), to the communication unit 22 of the use-side apparatus 20.

The use-side apparatus 20 that uses local correction information will be described.

Operations of the positioning signal receiving unit 21, the positioning unit 23, and the control unit 24 according to the second example embodiment are the same as those of the first example embodiment, and thus a description of the positioning signal receiving unit 21, the positioning unit 23, and the control unit 24 is omitted.

The communication unit 22 receives, from the communication unit 14 of the generation-side apparatus 10, local correction information, the position coordinates indicating the position of the generation-side apparatus 10 (reference position), and the estimated position coordinates of the generation-side apparatus 10 (estimated position).

The positioning error calculation unit 2 calculates positioning errors in time series, using the position coordinates indicating the position of the generation-side apparatus 10 (reference position), and the position coordinates of the generation-side apparatus 10 (estimated position) estimated based on positioning signals received from satellites. The positioning error calculation unit 2 calculates the distance between two points in a three-dimensional space (between the reference position and the estimated position), for example, and the distance is regarded as a positioning error.

The use determination unit 3 determines whether or not to use the local correction information, based on the calculated positioning error using the above-described (i) to (iii) methods.

[Apparatus Configuration]

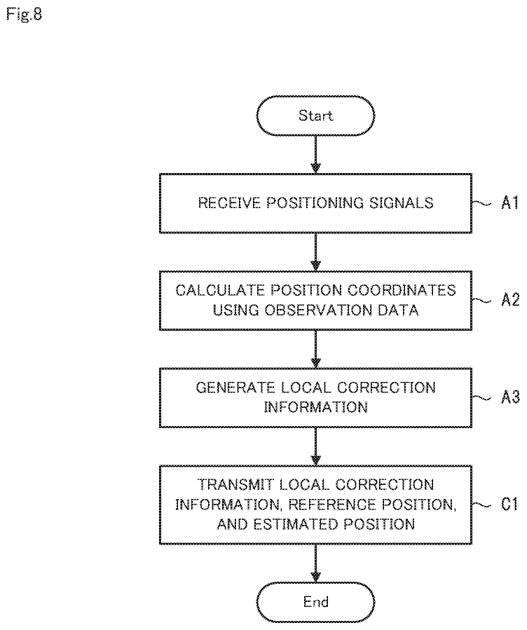

Next, operations of the positioning assistance apparatuses according to the second example embodiment will be described with reference to drawings. FIG. 8 is a diagram showing an example of operations of the positioning assistance apparatus of the generation-side apparatus.

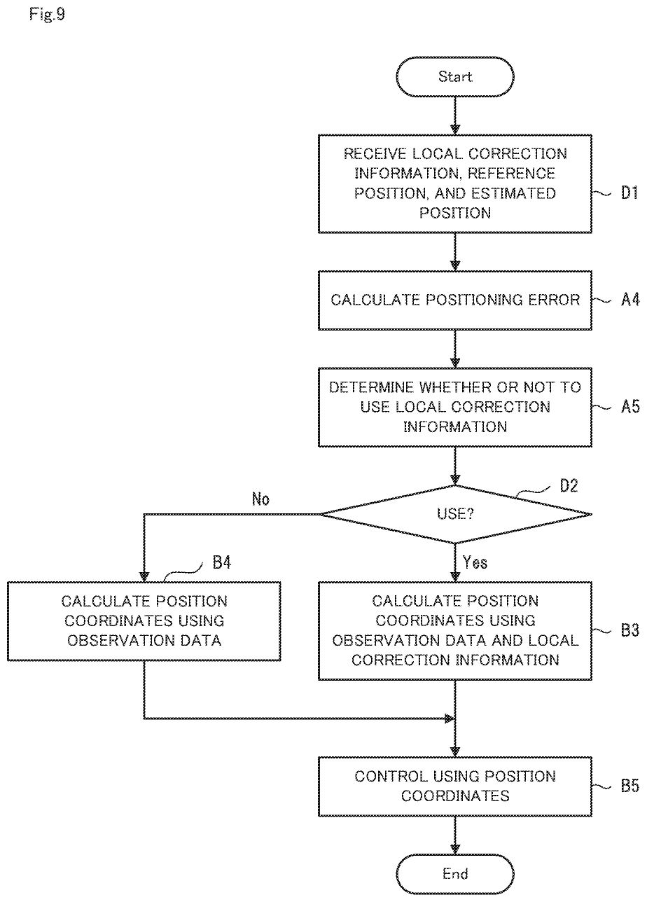

FIG. 9 is a diagram showing an example of operations of the positioning assistance apparatus of the use-side apparatus. In the following description, FIG. 7 will be referred to as appropriate. In addition, in the second example embodiment, the positioning assistance method is carried out by operating the positioning assistance apparatuses. Thus, a description of the positioning assistance method according to the second example embodiment is replaced with the following description of operations of the positioning assistance apparatuses.

Operations of the generation-side apparatus will be described with reference to FIG. 8.

First, the generation-side apparatus 10 executes the processing in steps A1 to A3. Steps A1 to A3 shown in FIG. 8 have been described in the first example embodiment, and a description thereof is omitted.

Next, the communication unit 14 transmits the local correction information, the position coordinates indicating the position of the generation-side apparatus 10 (reference position), and the estimated position coordinates of the generation-side apparatus 10 (estimated position), to the communication unit 22 of the use-side apparatus 20 (step C1).

Operation of the use-side apparatus will be described with reference to FIG. 9.

First, the communication unit 22 receives the local correction information, the position coordinates indicating the position of the generation-side apparatus 10 (reference position), and the estimated position coordinates of the generation-side apparatus 10 (estimated position) (step D1).

Next, in step A4, the positioning error calculation unit 2 calculates a positioning error, and in step A5, the use determination unit 3 determines whether or not to use the local correction information. Steps A4 and A5 have been described in the first example embodiment, and thus a description thereof is omitted.

If it is determined in step A5 that the local correction information is to be used (step D2: Yes), the positioning unit 23 executes the processing in step B3. In addition, if it is determined in step A5 that the local correction information is not to be used (step D2: No), the positioning unit 23 executes the processing in step B4. Note that steps B3, B4, and B5 have been described in the first example embodiment, and thus a description thereof is omitted.

### Effects in Second Example Embodiment

As described above, according to the second example embodiment, it is determined whether or not to use the local correction information, based on a positioning error, and positioning can be performed using valid local correction information, thus enabling the positioning accuracy to be improved.

[Program]

A program according to the second example embodiment may be a program for causing a generation-side computer to execute steps A1 to A3 and C1 shown in FIG. 8. In addition, the program according to the second example embodiment may be a program for causing a use-side computer to execute steps D1, A4, A5, D2, and B3 to B5 shown in FIG. 9.

It is possible to realize the generation-side or use-side positioning assistance apparatus and the positioning assistance method according to the second example embodiment by installing these programs onto the corresponding computers, and executing the programs. The processor of the generation-side computer functions as the positioning unit 12 and the local correction information generation unit 13, and performs processing.

In addition, the processor of the user-side computer functions as the positioning error calculation unit 2, the use determination unit 3, the positioning unit 23, and the control unit 24, and performs processing.

In addition, the program according to the second example embodiment may also be executed by a computer system constituted by a plurality of computers. In this case, for example, each generation-side computer may function as one of the positioning unit 12 and the local correction information generation unit 13. Each use-side computer may function as one of the positioning error calculation unit 2, the use determination unit 3, the positioning unit 23, and the control unit 24, for example.

### Third Example Embodiment

Regarding the satellite positioning system described in the above first and second example embodiments, an example has been described in which the positioning assistance apparatus 1 is provided in a generation-side apparatus or a use-side apparatus, but, in the third example embodiment, the positioning error calculation unit 2 of the positioning assistance apparatus 1 is provided in the generation-side apparatus 10, and the use determination unit 3 is provided in the use-side apparatus 20.

In the third example embodiment, the positioning error calculation unit 2 of the generation-side apparatus 10 calculates positioning error, using a reference position indicating the position of the generation-side apparatus 10 that generates local correction information and estimated position indicating the position of the generation-side apparatus 10 estimated based on positioning signal received from satellite.

Next, in the third example embodiment, the communication unit 14 of the generation-side apparatus 10 transmits the local correction information and the positioning error associated with each other, from the generation-side apparatus 10 to the use-side apparatus 20.

When local correction information and valid information are obtained, the communication unit 22 of the use-side apparatus 20 determines whether or not to use the local correction information, based on the obtained positioning error, using the above methods (i), (ii), and (iii).

### Effects in Third Example Embodiment

As described above, according to the third example embodiment, it is determined whether or not to use local correction information, based on positioning error, and positioning can be performed using valid local correction information, thus enabling the positioning accuracy to be improved.

[Physical Configuration]

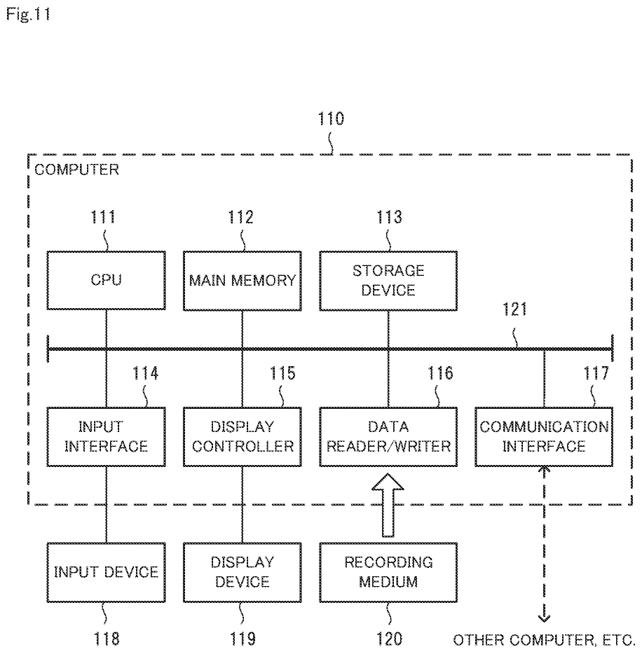

Here, a computer that realizes a positioning assistance apparatus by executing the generation-side or use-side program according to the first to third example embodiments will be described with reference to FIG. 11. FIG. 11 is a block diagram showing an example of a computer that realizes a positioning assistance apparatus according to the first to third example embodiments.

As shown in FIG. 11, a computer 110 includes a CPU (Central Processing Unit) 111, a main memory 112, a storage device 113, an input interface 114, a display controller 115, a data reader/writer 116, and a communication interface 117. These units are connected via a bus 121 so as to be able to perform data communication with each other. Note that the computer 110 may include a GPU (Graphics Processing Unit) or a FPGA (Field-Programmable Gate Array) in addition to the CPU 111 or instead of the CPU 111.

The CPU 111 loads a program (codes) according to the present exemplary embodiment stored in the storage device 113 to the main memory 112, and executes them in a predetermined order to perform various kinds of calculations. The main memory 112 is typically a volatile storage device such as a DRAM (Dynamic Random Access Memory). Also, the program according to the present exemplary embodiment is provided in the state of being stored in a computer-readable recording medium 120. Note that the program according to the present exemplary embodiment may be distributed on the Internet that is connected via the communication interface 117.

Specific examples of the storage device 113 include a hard disk drive, and a semiconductor storage device such as a flash memory. The input interface 114 mediates data transmission between the CPU 111 and an input device 118 such as a keyboard or a mouse. The display controller 115 is connected to a display device 119, and controls the display of the display device 119.

The data reader/writer 116 mediates data transmission between the CPU 111 and the recording medium 120, reads out the program from the recording medium 120, and writes the results of processing performed in the computer 110 to the recording medium 120. The communication interface 117 mediates data transmission between the CPU 111 and another computer.

Specific examples of the recording medium 120 include general-purpose semiconductor storage devices such as a CF (Compact Flash (registered trademark)) and a SD (Secure Digital), a magnetic recording medium such as a flexible disk, and an optical recording medium such as a CD-ROM (Compact Disk Read Only Memory).

### Supplementary Note

The following supplementary notes are also disclosed in relation to the above-described exemplary embodiments. One or all of the above-described exemplary embodiments can be expressed as, but are not limited to, Supplementary Note 1 to Supplementary Note 25 described below.

(Supplementary Note 1)

A positioning assistance apparatus to be provided in a generation-side apparatus that generates local correction information, the positioning assistance apparatus comprising:

a positioning error calculation unit that calculates a positioning error using a reference position indicating a position of the generation-side apparatus that generates the local correction information and an estimated position indicating a position of the generation-side apparatus estimated based on a positioning signal received from a satellite; and

a use determination unit that determines whether or not to use the local correction information, based on the calculated positioning error.

(Supplementary Note 2)

The positioning assistance apparatus according to Supplementary Note 1, wherein, if the positioning error is smaller than or equal to a first threshold value, the use determination unit determines that the local correction information is to be used.

(Supplementary Note 3)

The positioning assistance apparatus according to Supplementary Note 1,

wherein the use determination unit counts a numerical quantity of positioning errors that are smaller than or equal to a first threshold value, every set time, and

if the counted numerical quantity is larger than or equal to a second threshold value that is used for determining whether or not to use the local correction information, the use determination unit determines that the local correction information is to be used.

(Supplementary Note 4)

The positioning assistance apparatus according to Supplementary Note 1,

wherein the use determination unit executes statistical processing on the positioning error and calculates a statistical value, every set time, and

if the calculated statistical value satisfies a statistical value determination condition that is used for determining whether or not to use the local correction information, the use determination unit determines that the local correction information is to be used.

(Supplementary Note 5)

A positioning assistance apparatus to be provided in a use-side apparatus that uses local correction information, the positioning assistance apparatus comprising:

a use determination unit that determines whether or not to use the local correction information, based on a positioning error calculated using a reference position indicating a position of a generation-side apparatus that generates the local correction information and an estimated position indicating a position of the generation-side apparatus estimated based on a positioning signal received from a satellite.

(Supplementary Note 6)

The positioning assistance apparatus according to Supplementary Note 5,

wherein, if the positioning error is smaller than or equal to a first threshold value, the use determination unit determines that the local correction information is to be used.

(Supplementary Note 7)

The positioning assistance apparatus according to Supplementary Note 5,

wherein the use determination unit counts a numerical quantity of positioning errors that are smaller than or equal to a first threshold value, every set time, and

if the counted numerical quantity is larger than or equal to a second threshold value that is used for determining whether or not to use the local correction information, the use determination unit determines that the local correction information is to be used.

(Supplementary Note 8)

The positioning assistance method according to Supplementary Note 5,

wherein the use determination unit executes statistical processing on the positioning error and calculates a statistical value, every set time, and

if the calculated statistical value satisfies a statistical value determination condition that is used for determining whether or not to use the local correction information, the use determination unit determines that the local correction information is to be used.

(Supplementary Note 9)

A positioning assistance method for a generation-side apparatus that generates local correction information, the method comprising:

a step of calculating a positioning error using a reference position indicating a position of the generation-side apparatus that generates the local correction information and an estimated position indicating a position of the generation-side apparatus estimated based on a positioning signal received from a satellite; and

a step of determining whether or not to use the local correction information, based on the calculated positioning error.

(Supplementary Note 10)

The positioning assistance method according to Supplementary Note 9,

wherein, in the use determination step,

if the positioning error is smaller than or equal to a first threshold value, it is determined that the local correction information is to be used.

(Supplementary Note 11)

The positioning assistance method according to Supplementary Note 9,

wherein, in the use determination step,

a numerical quantity of positioning errors that are smaller than or equal to a first threshold value is counted every set time; and

if the counted numerical quantity is larger than or equal to a second threshold value that is used for determining whether or not to use the local correction information, it is determined that the local correction information is to be used.

(Supplementary Note 12)

The positioning assistance method according to Supplementary Note 9,

wherein, in the use determination step, statistical processing is executed on the positioning error and a statistical value is calculated, every set time, and

if the calculated statistical value satisfies a statistical value determination condition that is used for determining whether or not to use the local correction information, it is determined that the local correction information is to be used.

(Supplementary Note 13) A positioning assistance method for a use-side apparatus that uses local correction information, the method comprising:

a step of calculating a reference position indicating a position of a generation-side apparatus that generates the local correction information and an estimated position indicating a position of the generation-side apparatus estimated based on a positioning signal received from a satellite, using a positioning error; and

a step of determining whether or not to use the local correction information, based on the calculated positioning error.

(Supplementary Note 14)

The positioning assistance method according to Supplementary Note 13,

wherein, in the use determination step,

if the positioning error is smaller than or equal to a first threshold value, it is determined that the local correction information is to be used.

(Supplementary Note 15)

The positioning assistance method according to Supplementary Note 13,

wherein, in the use determination step, a numerical quantity of positioning errors that are smaller than or equal to a first threshold value is counted every set time; and

if the counted numerical quantity is larger than or equal to a second threshold value that is used for determining whether or not to use the local correction information, it is determined that the local correction information is to be used.

(Supplementary Note 16)

The positioning assistance method according to Supplementary Note 13,

wherein, in the use determination step, statistical processing is executed on the positioning error and a statistical value is calculated, every set time, and

if the calculated statistical value satisfies a statistical value determination condition that is used for determining whether or not to use the local correction information, it is determined that the local correction information is to be used.

(Supplementary Note 17)

A computer-readable recording medium that includes a program recorded thereon, the program including instructions that cause a computer of a generation-side apparatus that generates local correction information to carry out:

a step of calculating a positioning error using a reference position indicating a position of the generation-side apparatus that generates the local correction information and an estimated position indicating a position of the generation-side apparatus estimated based on a positioning signal received from a satellite; and

a step of determining whether or not to use the local correction information, based on the calculated positioning error.

(Supplementary Note 18)

The computer-readable recording medium according to Supplementary Note 17,

wherein, in the use determination step,

if the positioning error is smaller than or equal to a first threshold value, it is determined that the local correction information is to be used.

(Supplementary Note 19)

The computer-readable recording medium according to Supplementary Note 17,

wherein, in the use determination step,

a numerical quantity of positioning errors that are smaller than or equal to a first threshold value is counted every set time, and

if the counted numerical quantity is larger than or equal to a second threshold value that is used for determining whether or not to use the local correction information, it is determined that the local correction information is to be used.

(Supplementary Note 20)

The computer-readable recording medium according to Supplementary Note 17,

wherein, in the use determination step,

statistical processing is executed on the positioning error and a statistical value is calculated, every set time, and

if the calculated statistical value satisfies a statistical value determination condition that is used for determining whether or not to use the local correction information, it is determined that the local correction information is to be used.

(Supplementary Note 21)

A computer-readable recording medium that includes a program recorded thereon, the program including instructions that cause a computer of a use-side apparatus that uses local correction information to carry out:

a step of calculating a reference position indicating a position of a generation-side apparatus that generates the local correction information and an estimated position indicating a position of the generation-side apparatus estimated based on a positioning signal received from a satellite, using a positioning error; and

a step of determining whether or not to use the local correction information, based on the calculated positioning error.

(Supplementary Note 22)

The computer-readable recording medium according to Supplementary Note 21,

wherein, in the use determination step,

if the positioning error is smaller than or equal to a first threshold value, it is determined that the local correction information is to be used.

(Supplementary Note 23)

The computer-readable recording medium according to Supplementary Note 21,

wherein, in the use determination step,

a numerical quantity of positioning errors that are smaller than or equal to a first threshold value is counted every set time, and

if the counted numerical quantity is larger than or equal to a second threshold value that is used for determining whether or not to use the local correction information, it is determined that the local correction information is to be used.

(Supplementary Note 24)

The computer-readable recording medium according to Supplementary Note 21,

wherein, in the use determination step,

statistical processing is executed on the positioning error and a statistical value is calculated, every set time, and

if the calculated statistical value satisfies a statistical value determination condition that is used for determining whether or not to use the local correction information, it is determined that the local correction information is to be used.

(Supplementary Note 25)

A satellite positioning system comprising a generation-side apparatus and a use-side apparatus,
wherein the generation-side apparatus calculates a positioning error using a reference position indicating a position of the generation-side apparatus that generates local correction information and an estimated position indicating a position of the generation-side apparatus estimated based on a positioning signal received from a satellite, and

the use-side apparatus determines whether or not to use the local correction information, based on the calculated positioning error.

Although the invention has been described above with reference to the example embodiments above, the invention is not limited to the above example embodiments. Various modifications understandable to a person skilled in the art can be made to configurations and details of the invention, within the scope of the invention.

This application is based upon and claims the benefit of priority from Japanese Patent Application No. 2019-162453, filed Sep. 5, 2019, the disclosure of which is incorporated herein in its entirety by reference.

### INDUSTRIAL APPLICABILITY

As described above, according to the invention, it is possible to improve the positioning accuracy. The invention is useful in a technical field in which positioning needs to be performed using a satellite positioning system.

### LIST OF REFERENCE SIGNS

1 Positioning assistance apparatus
2 Positioning error calculation unit
3 Use determination unit
10 Generation-side apparatus
11 Positioning signal receiving unit
12 Positioning unit
13 Local correction information generation unit
14 Communication unit
20 Use-side apparatus
21 Positioning signal receiving unit
22 Communication unit
2433 Positioning unit
24 Control unit
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. A positioning assistance apparatus to be provided in a generation-side apparatus that generates local correction information, the positioning assistance apparatus comprising:
positioning error calculation unit that calculates a positioning error using a reference position indicating a position of the generation-side apparatus that generates the local correction information and an estimated position indicating a position of the generation-side apparatus estimated based on a positioning signal received from a satellite; and
use determination unit that determines whether or not to use the local correction information, based on the calculated positioning error.

2. The positioning assistance apparatus according to claim 1,
wherein, if the positioning error is smaller than or equal to a first threshold value, the use determination unit determines that the local correction information is to be used.

3. The positioning assistance apparatus according to claim 1,
wherein the use determination unit counts a numerical quantity of positioning errors that are smaller than or equal to a first threshold value, every set time, and
if the counted numerical quantity is larger than or equal to a second threshold value that is used for determining whether or not to use the local correction information, the use determination unit determines that the local correction information is to be used.

4. The positioning assistance apparatus according to claim 1,
wherein the use determination unit executes statistical processing on the positioning error and calculates a statistical value, every set time, and
if the calculated statistical value satisfies a statistical value determination condition that is used for determining whether or not to use the local correction information, the use determination unit determines that the local correction information is to be used.

5. A positioning assistance apparatus to be provided in a use-side apparatus that uses local correction information, the positioning assistance apparatus comprising:
use determination unit that determines whether or not to use the local correction information, based on a positioning error calculated using a reference position indicating a position of a generation-side apparatus that generates the local correction information and an estimated position indicating a position of the generation-side apparatus estimated based on a positioning signal received from a satellite.

6. A positioning assistance method for a generation-side apparatus that generates local correction information, the method comprising:
calculating a positioning error using a reference position indicating a position of the generation-side apparatus that generates the local correction information and an estimated position indicating a position of the generation-side apparatus estimated based on a positioning signal received from a satellite; and
determining whether or not to use the local correction information, based on the calculated positioning error.

7. A positioning assistance method for a use-side apparatus that uses local correction information, the method comprising:
calculating a positioning error using a reference position indicating a position of a generation-side apparatus that generates the local correction information and an estimated position indicating a position of the generation-side apparatus estimated based on a positioning signal received from a satellite; and
determining whether or not to use the local correction information, based on the calculated positioning error.

8. A non-transitory computer-readable recording medium that includes a program recorded thereon, the program including instructions that cause a computer of a generation-side apparatus that generates local correction information to carry out processing for:
calculating a positioning error using a reference position indicating a position of the generation-side apparatus that generates the local correction information and an estimated position indicating a position of the generation-side apparatus estimated based on a positioning signal received from a satellite; and
determining whether or not to use the local correction information, based on the calculated positioning error.

9. A non-transitory computer-readable recording medium that includes a program recorded thereon, the program including instructions that cause a computer of a use-side apparatus that uses local correction information to carry out processing for:
determining whether or not to use the local correction information, based on a plurality of positioning errors calculated using a reference position indicating a position of a generation-side apparatus that generates the local correction information and an estimated position indicating a position of the generation-side apparatus estimated based on a positioning signal received from a satellite.

10. A satellite positioning system comprising a generation-side apparatus and a use-side apparatus,
wherein the generation-side apparatus calculates a positioning error using a reference position indicating a position of the generation-side apparatus that generates local correction information and an estimated position indicating a position of the generation-side apparatus estimated based on a positioning signal received from a satellite, and
the use-side apparatus determines whether or not to use the local correction information, based on the calculated positioning error.

11. The positioning assistance apparatus according to claim 5,
wherein, if the positioning error is smaller than or equal to a first threshold value, the use determination unit determines that the local correction information is to be used.

12. The positioning assistance apparatus according to claim 5,
wherein, the use determination unit counts a numerical quantity of positioning errors that are smaller than or equal to a first threshold value, every set time, and
if the counted numerical quantity is larger than or equal to a second threshold value that is used for determining whether or not to use the local correction information, the use determination unit determines that the local correction information is to be used.

13. The positioning assistance method according to claim 5,
wherein, the use determination unit executes statistical processing on the positioning error and calculates a statistical value, every set time, and
if the calculated statistical value satisfies a statistical value determination condition that is used for determining whether or not to use the local correction information, the use determination unit determines that the local correction information is to be used.

14. The positioning assistance method according to claim 9,
wherein, if the positioning error is smaller than or equal to a first threshold value, it is determined that the local correction information is to be used.

15. The positioning assistance method according to claim 9,
wherein, a numerical quantity of positioning errors that are smaller than or equal to a first threshold value is counted every set time; and
if the counted numerical quantity is larger than or equal to a second threshold value that is used for determining whether or not to use the local correction information, it is determined that the local correction information is to be used.

16. The positioning assistance method according to claim 9,
wherein, statistical processing is executed on the positioning error and a statistical value is calculated, every set time, and
if the calculated statistical value satisfies a statistical value determination condition that is used for determining whether or not to use the local correction information, it is determined that the local correction information is to be used.

17. The positioning assistance method according to claim 13,
wherein, if the positioning error is smaller than or equal to a first threshold value, it is determined that the local correction information is to be used.

18. The positioning assistance method according to claim 13,
wherein, a numerical quantity of positioning errors that are smaller than or equal to a first threshold value is counted every set time; and
if the counted numerical quantity is larger than or equal to a second threshold value that is used for determining whether or not to use the local correction information, it is determined that the local correction information is to be used.

19. The positioning assistance method according to claim 13,
wherein, statistical processing is executed on the positioning error and a statistical value is calculated, every set time, and
if the calculated statistical value satisfies a statistical value determination condition that is used for determining whether or not to use the local correction information, it is determined that the local correction information is to be used.
